(19) United States
(12) Patent Application Publication
(10) Pub. No.: US 2019/0084344 A1
(43) Pub. Date: Mar. 21, 2019

(54) RETRACTABLE BOUNDARY APPARATUS AND SYSTEM

(71) Applicant: COMSERO, INC., Denver, CO (US)

(72) Inventors: Anthony Franco, Broomfield, CO (US); Andrew Valentine, Wheat Ridge, CO (US)

(73) Assignee: COMSERO, INC., Denver, CO (US)

(21) Appl. No.: 16/138,584

(22) Filed: Sep. 21, 2018

Related U.S. Application Data
(60) Provisional application No. 62/561,581, filed on Sep. 21, 2017.

(51) Int. Cl. B43L 1/08; B43K 23/00

(52) U.S. Cl. CPC B43L 1/08; B43L 1/123; B43K 23/001

(57) ABSTRACT

Certain embodiments of the invention include an apparatus for creating a line. Certain embodiments of an apparatus include two or more reels having an extendable and retractable cord. Pulling the two or more reels apart allows for the creation of a line of various sizes. In certain embodiments, the two reels share a single cord. In certain embodiments, a first reel has a first cord with a first attachment end that joins with another attachment end. Certain embodiments include a reel with a magnet, allowing attachment to a magnetic surface. Certain embodiments of the invention include a system for creating a line. In certain embodiments, the system includes an apparatus, and a pin having a magnet. Certain embodiments of the pin help to change the direction of the cord.

### CROSS REFERENCE TO RELATED APPLICATIONS

This application claims the benefit of U.S. Provisional Patent Application 62/561,581, filed on Sep. 21, 2017, which is hereby incorporated by reference in its entirety.

### FIELD OF THE INVENTION

Embodiments of the invention generally relate to the field of writing implements, and more particularly to dry erase white boards and the like.

### BACKGROUND OF THE INVENTION

Dry erase boards typically include a board or substrate. The board or substrate is optionally coated with an enamel, film, plastic, ultraviolet cured liquid, liquid varnish, or porcelain finish, and the like. Specially designed markers are used to write on the board or substrate. While the ink of the marker dries on the substrate, the ink does not bond to the substrate surface. Thus, writing is easily removed with a soft eraser, cloth, finger, etc.

During collaborative sessions, meetings, presentations, and the like, participants can contribute to the discussion by writing, erasing, and otherwise interacting with the dry erase board. During brainstorming sessions, for example, participants typically share, or use their own dry erase marker to write down and contribute ideas. In some situations, participants use pieces of paper with adhesive (commonly known as sticky notes). Ideas are written on sticky notes, and placed on the board. Sticky notes allow for ideas to be moved around on the board, such that similar ideas can be placed in proximity. Sticky notes also allow for certain ideas to be separated from one another, or organized using the area available on the board.

Although sticky notes allow for rapid attachment and removal from a dry erase board, sticky notes are typically one-time use. Because sticky notes are made of paper, using a pen or marker permanently marks each sticky note. Though a pencil and rubber eraser can be used on sticky notes, it is often inefficient to do so.

Additionally, when categorizing, storing, or otherwise organizing ideas on a board, lines may be drawn to separate concepts. For example, during a collaborative session, information may be organized by drawing out the lines that comprise the rows and columns of a table. In another example, participants may write or draw out separate set of lists, where each set is divided by lines. Participants may contribute ideas to the board by writing within the lines, next to the lines, or otherwise in proximity to the lines. Participants may also use sticky notes, by moving the notes around the dry erase board and within the drawn lines. Using lines during a collaborative session allows participants to quickly view ideas, better organize ideas, and have better collaborative outcomes.

However, there are some disadvantages to using drawn lines on dry erase boards. Unless care is taken to draw the line, drawn lines are seldom neat or straight. A tool, such as a straight edge may be used, but such tool is not always readily available. The drawn lines are susceptible to being accidentally erased. Unintentional erasure may lead to lost information. Drawn lines are also more difficult to change. A participant must erase the line, and redraw the line. Erasing the line may lead to accidental erasure of important information.

When working in a fast-paced collaborative environment, establishing lines quickly and efficiently becomes a priority.

Several patents and patent publications describe a retractable cord and similar devices. For example, U.S. Pat. No. 9,718,640 and U.S. Patent Publication No. 2017/0022025 to Burner et al., entitled “Retractable Badge Reel with Button Display,” and incorporated herein by reference, generally discloses a badge reel having a spring-retractable cord configured to hold a badge. The reel includes a recess configured to house a magnet. However, this reference is limited to a self-retractable cord attachment to an object, such as a badge.

U.S. Pat. No. 6,290,158 to Huang, entitled “Reel Device Carried on One's Person,” and incorporated herein by reference, generally discloses a reel having an internal pulling rope with a clip or clamp for attachment. A swivel action is provided by the configuration of the clamp attachment to the reel. However, this reference is limited to the attachment of the reel through a clamp, and for the connection to a decorative piece of various modeling decorations.

A number of patents and patent publications describe a general retractable cord device. These references include, for example: U.S. Pat. No. 5,535,960 to Skowronski et al., incorporated by reference, describing a “Cord Reel Assembly”; U.S. Pat. No. 5,509,616 to Millen Jr. et al., incorporated by reference, describing a “Retractable Chalk Line Device”; U.S. Pat. No. 5,598,727 to White, incorporated by reference, describing a “Locks for Bicycles and the Like”; U.S. Pat. No. 5,833,165 to Paugh, incorporated by reference, describing a “Retraction Reel for Keys and the Like”; U.S. Pat. No. 5,954,288 to Shih, incorporated by reference, describing a “Extensible Hanging Device”; U.S. Pat. No. 6,199,784 to Wang et al., incorporated by reference, describing a “Automatically Rewindable Wire Device”; U.S. Pat. No. 6,199,785 to Paugh, incorporated by reference, describing a “Ratchet Mechanism for a Reel”; U.S. Pat. No. 6,325,665 to Chung et al., incorporated by reference, describing a “Power Adapter with Cable Storage Device”; U.S. Pat. No. 6,364,237 to Kagel, incorporated by reference, describing a “Retractable Badgeholder with Spinning Display”; U.S. Pat. No. 6,439,490 to Hwang, incorporated by reference, describing a “Wire Reeler”; U.S. Pat. No. 6,616,080 to Edwards et al., incorporated by reference, describing a “Retractable Cord Device”; U.S. Pat. No. 6,694,922 to Walter et al., incorporated by reference, describing a “Retractable Leash Assembly”; U.S. Pat. No. 6,929,209 to Baumgarten, incorporated by reference, describing a “Self-Orienting Retractable ID Card Holder”; U.S. Pat. No. 7,007,882 to Raia et al., incorporated by reference, describing a “Retractable Badge Reel with Billboard Display”; U.S. Pat. No. 7,374,123 to Han, incorporated by reference, describing a “Rewind Mechanism”; U.S. Pat. No. 7,661,620 to Fields, incorporated by reference, describing a “Personal Accessory Carrying Device”; U.S. Pat. No. 7,665,684 to Salentine et al., incorporated by reference, describing a “Retracting Tether for Cell Phones, Pagers and PDA's”; U.S. Pat. No. 7,755,483 to Schmidt et al., incorporated by reference, describing a “Article Holding and Tracking Device”; U.S. Pat. No. 7,762,215 to Horton et al., incorporated by reference, describing a “Universal Retractable Zip Clip”; U.S. Pat. No. 8,402,925 to Le Croix et al., incorporated by reference, describing a “Retractable Animal Leash”; U.S. Pat. No. 8,534,587 to He, incorporated by reference, describing a “Automatic Positioning Winder”; U.S. Pat. No. 8,746,519 to Young et al., incorporated by reference, describing a “Releasable Attachment Apparatus”; U.S. Pat. No. 8,757,532 to Votel et al., incorporated by reference, describing a “Retractable Lanyard”; U.S. Patent Publication No. 2004/0032741 to Tai, incorporated by reference, describing a “Lamp Reel”; U.S. Patent Publication No. 2007/0278265 to Contente, incorporated by reference, describing a “System for Carrying Portable Device”; U.S. Patent Publication No. 2008/0035778 to Belden et al., incorporated by reference, describing a “Swivel Recoiler”; U.S. Patent Publication No. 2008/0042000 to Horton, incorporated by reference, describing a “Universal Retractable Zip Clip”; U.S. Patent Publication No. 2008/0283651 to Ito et al., incorporated by reference, describing a “Hanging Device”; U.S. Patent Publication No. 2013/0008392 to Holmstrom, incorporated by reference, describing a “Retractable Leash System”; U.S. Patent Publication No. 2014/0000322 to Williams, incorporated by reference, describing a “Mobile Lock with Retractable Cable”; and U.S. Patent Publication No. 2015/0223588 to DeNittis et al., incorporated by reference, describing a “Identification Badge Holder.” However, again, the references generally describe and teach the attachment of the retractable device to, for example, a badge, ID holder, phone, and pet.

Therefore, there is a need for a system and apparatus that allows users to rapidly create straight lines for a dry erase board. There is a need for an apparatus that creates consistently straight lines. There is a need for a system and apparatus that allows easy modification of the lines. There is also a need for an apparatus that allows ideas to be linked efficiently.

### SUMMARY OF THE INVENTION

It is the object of certain embodiments of the invention to provide a system and apparatus for quickly and effectively imparting a line or a plurality of lines, and be used on a dry erase board. It is the object of certain embodiments to provide a system and apparatus for imparting consistent, straight lines. It is also the object of certain embodiments to quickly modify the lines as to create shapes. It is also the object of certain embodiments to quickly adjust, move, or otherwise modify the imparted line, and in some cases, to do so without leaving a mess. It is also the object of the invention to impart a line effortlessly, and anywhere across a surface of a dry erase board.

Certain embodiments of the invention include an apparatus for creating a line. Certain embodiments of an apparatus include two or more reels having an extendable and retractable cord. Pulling the two or more reels apart allows for the creation of a line of various sizes. In certain embodiments, an apparatus includes a cord attached to one or more reels. In certain embodiments, a cord is extendable from a first reel and a second reel. In certain embodiments, the two reels share a single cord.

In certain embodiments, a first reel has a first cord with a first attachment end that joins with another attachment end. Certain embodiments include a reel with a magnet, allowing attachment to a magnetic surface. Certain embodiments of the invention include a system for creating a line. In certain embodiments, the system includes an apparatus, and a pin having a magnet. Certain embodiments of the pin help to change the direction of the cord.

These and other advantages described in the Summary will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### DESCRIPTION OF THE DRAWINGS

FIG. 1A: A line creating apparatus in certain embodiments of the invention.

FIG. 1B: An internal mechanism of a line creating apparatus in certain embodiments of the invention.

FIG. 2: A line creating apparatus in certain embodiments of the invention.

FIG. 3: A line creating apparatus in certain embodiments of the invention.

FIG. 4: A line creating apparatus in certain embodiments of the invention.

FIG. 5: Perspective view of a line creating apparatus on a surface in certain embodiments of the invention.

FIG. 6: A front view of a system including a line creating apparatus on a surface in certain embodiments of the invention.

FIG. 7: An example of a line creating apparatus embodiment in use.

FIG. 8A: A perspective view of a pin in certain embodiments of the invention.

FIG. 8B: A side view of a pin in certain embodiments of the invention.

FIG. 8C: A side view of a reel in certain embodiments of the invention.

FIG. 9A: A front view of a pin and line creating apparatus in certain embodiments of the invention.

FIG. 9B: A front view of a pin and line creating apparatus in certain embodiments of the invention.

FIG. 10: A sectional view of a reel in certain embodiments.

### DETAILED DESCRIPTION

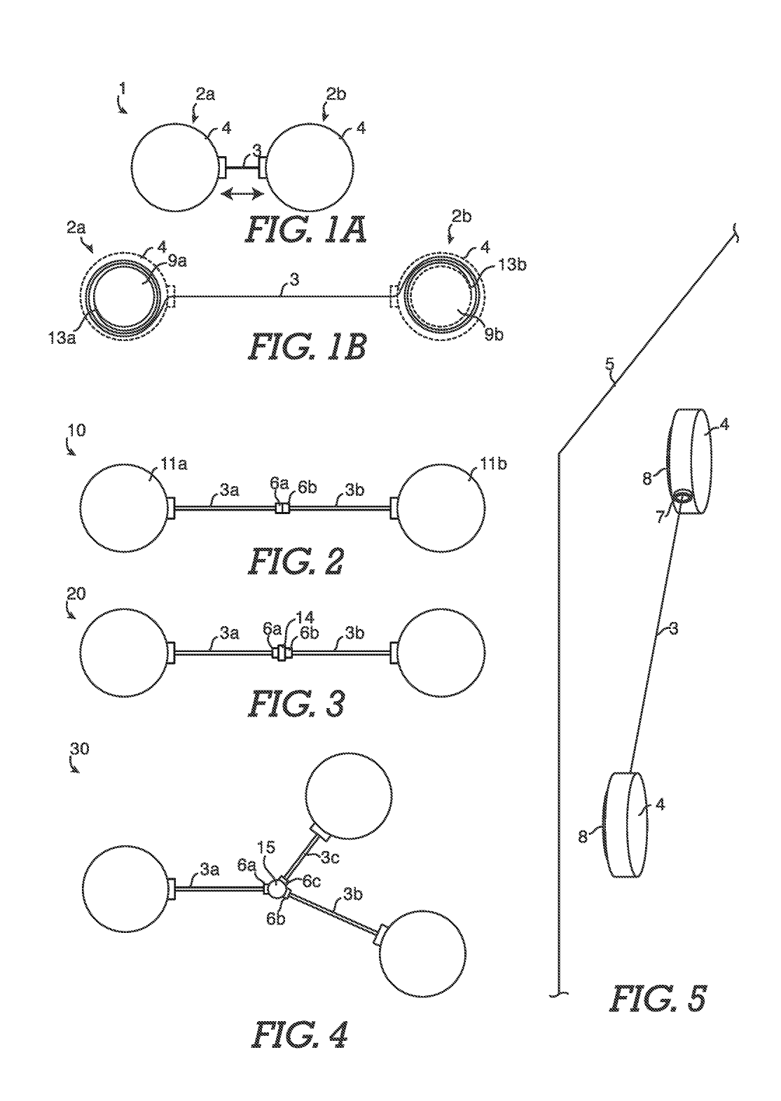

Referring to FIG. 1A, in certain embodiments, a line creating apparatus 1 includes a cord attached to one or more reels. As shown in FIG. 1A, a line creating apparatus includes a first reel 2a and a second reel 2b. A reel 2a, 2b includes a cord 3 extendable from the reel housing 4. Referring to, for example, FIG. 5, a cord 3 passes through an opening 7 located on a surface of the housing 4. In certain embodiments, the line creating apparatus 1 shares a cord 3 between a first reel 2a and a second reel 2b. Referring to FIG. 1B, the reel housing 4 stores the length of the cord 3, for example, by encircling a spool 9a, 9b, located in a first reel 2a and a second reel 2b. In certain embodiments, a first end 13a of a cord 3 is attached to a first spool 9a, and a second end 13b of a cord 3 is attached to a second spool 9b. In certain embodiments, a segment of a cord 3 is partially wound on a first spool 9a, and another segment is partially wound on a second spool 9b, such that the reels 2a, 2b are in proximity to one another when in the line creating apparatus is in a resting or non-extended position.

Referring to FIG. 10, in certain embodiments, a reel as described herein includes a spiral torsion spring 32. In certain embodiments, a spring 32 is located within the annular opening 31 of the spool 9. A spring 32 has a first end 33 affixed to a spool 9, and a second end 34 affixed to a housing, for example, to a post 35. The spool is rotatable within the housing, and the spring 32 biases the rotation of the housing towards a certain direction when the spring is loaded. Extension of a cord out of the housing spins the spool 9 about a central axis and loads the spring. The loaded spring provides a force to retract 3 the cord back into the housing. In certain embodiments, the line creating apparatus includes reels that contain springs with substantially similar spring constants. Having substantially similar spring constants allows each reel to impart an equal and opposite force, and effectively allowing any point on a cord to remain stationary. In certain embodiments, in line creating apparatuses where the reels share a cord (as seen, for example, in FIG. 1A and FIG. 1B), the orientation of the springs (either rotating clockwise or counterclockwise) found in the first reel and second reel may be the same (both rotating in the same direction), or may be opposing (one rotating clockwise, one rotating counterclockwise).

In an embodiment of the invention, the orientation and location of the springs allows for the placement of an identification apparatus, such as a marker. The intersection point of two or more cords, each linking two housings each containing a spool and spring, allows for a point of reference to be held in place at an intersection point. In an embodiment, the multiple springs allow for the placement of an identification apparatus, located at a point on the cord, held in place at any point on the straight line between each of the housings at either end. The present inventor has recognized that the multi-springed apparatus, whereby two housings at either end of a cord each contain a spring and a spool, allow for placement of a marker piece at any point in contact with the cord between a plurality of housings and/or spools. In varying embodiments of the invention, the identification apparatus takes the form of the coupling 14, and/or any part of the combination of one or more attachment ends 6a, 6b, as depicted in FIGS. 2 and 3. In an alternative embodiment, where more than one cord intersects, the identification apparatus takes the form of a coupling 15 that exists at the intersection point between the two or more cords, as depicted in FIG. 4.

Referring to FIG. 2, in certain embodiments, a line creating apparatus 10 has a first reel 11a and a second reel 11b. A first reel 11a has a first cord 3a, where the first cord 3a terminates at a first attachment end 6a. Still referring to FIG. 2, a second reel 11b has a second cord 3b, where the second cord 3b terminates at a second attachment end 6b. The attachment ends 6a, 6b attach to each other through an attachment feature. The attachment feature includes, but is not limited to, magnets, compressive fit, pin and slot connection, and pin and hole connection. The cords 3a, 3b are extendable from the first reel 11a and second reel 11b.

Referring to FIG. 3, in certain embodiments of the invention, a line creating apparatus 20 has a coupling 14. As shown in FIG. 3, a coupling 14 joins attachment ends 6a, 6b located on cords 3a, 3b. Referring to FIG. 4, in certain embodiments of the invention, a line creating apparatus 30 has a coupling 15. As shown in FIG. 4, a coupling 15 joins attachment ends attachment ends 6a, 6b, 6c located on cords 3a, 3b, 3c. In certain embodiments, a coupling 15 connects a plurality of attachment ends. It will be appreciated that in certain embodiments, coupling 15 is provided in a number of different sizes, in order to accommodate a plurality of attachment ends.

Referring to FIG. 5, certain embodiments are attached to a surface 5. In certain embodiments, the surface 5 has magnetic properties. For example, a surface 5 includes, but is not limited to a magnetic sheet, a magnetic white board, and a magnetic wall. The housing 4 of a reel has a magnet 8 allowing attachment and detachment from a surface 5. The length of the cord can be adjusted by adjusting the placement of the reel along the surface.

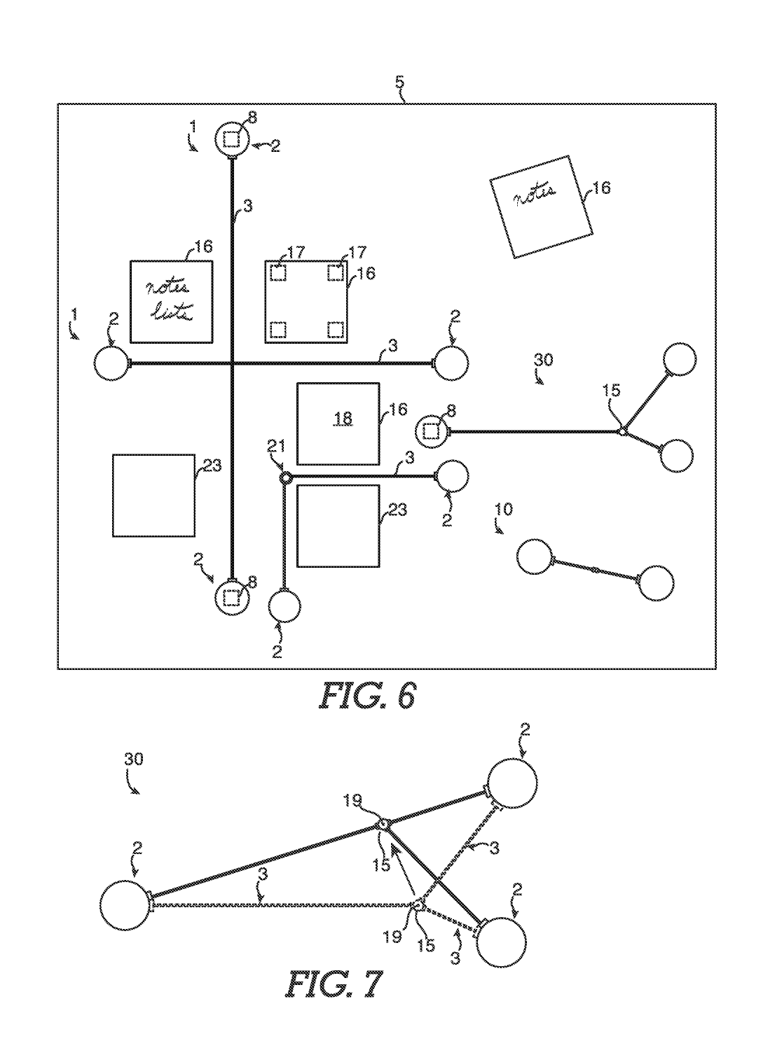

Referring to FIG. 6, certain embodiments comprise a system of a plurality of line drawing apparatuses. For example, as seen in FIG. 6, the system includes one or more apparatuses 1, 10, 30. In certain embodiments, the system includes a tile 16 or panel having a magnet 17, where a face 18 has a surface for writing with a writing utensil or implement. The tile is attached to a surface 5 having magnetic properties. A line creating apparatus 1 (also, for example, a line creating apparatus 10, 30) is further attached to the surface 5 through a magnet 8. Still referring to FIG. 6, the line creating apparatus 1 creates a line with the cord 3 located between reels 2. The placement of one reel relative to a second reel determines the length of the cord 3, as well as the angle of the cord on a surface 5. Generally, the apparatus allows flexibility in placement of the cord. Additionally, a user can place a plurality of tiles 16 or a plurality of sticky notes 23 on a surface, and divide such plurality of tiles and sticky notes with the line creating apparatus. In certain embodiments, cords are provided in different colors. For example, cords of one color may allow a user to distinguish it from cords of another color.

Referring to FIG. 7, in certain embodiments, the line creating apparatus 30 includes three or more reels 2, where each reel has a cord 3 attached to a coupling 15. The location that the cords converge may be referred to as a focal point 19. In certain embodiments, the reels 2 contain springs that have substantially similar spring constants. In certain embodiments, a coupling 15 includes a magnet. Translocation of the focal point 19 from a first point to a second point, as illustrated in FIG. 7, allows the focal point 19 to remain stationary at a new position, depending on the location of the new position. In certain embodiments, a pin 21 helps to keep the coupling 15 stationary at a focal point.

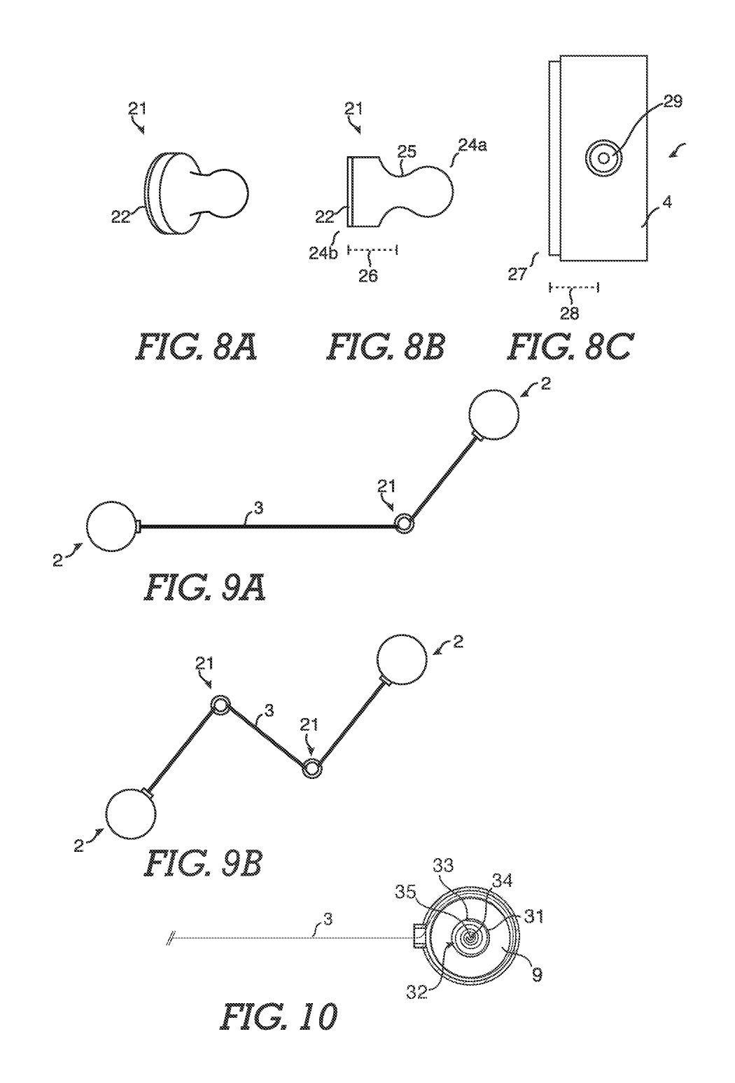

In certain embodiments, a line creating system includes a pin 21. Referring to FIG. 8A and FIG. 8B, the pin 21 has a first end 24a and a second end 24b, where the second end 24b includes a magnet 22. The pin 21 has an indent 25 to accommodate a cord 3. Referring to FIG. 8B and FIG. 8C, the distance 26 between an indent 25 and the pin second end 24b is substantially similar with the distance 28 between a reel 2 bottom end 27 and the opening 29 located on the reel housing 4. Referring to FIG. 6, FIG. 9A, and FIG. 9B, during use, the pin 21 can affect the linear direction of the cord 3. The placement of the pin 21 between the reel 2 allows adjustment of the length, as well as the linear direction of the cord.

### EXAMPLES

### Example 1

During a brainstorming session, the tiles may serve as a surface for writing notes. The line creating apparatus 1 (also, for example, line creating apparatus 10, 20, 30) may act as a boundary to separate out the content written on the tiles. The apparatus allows effective organization of ideas, and leading to an effective outcome from the session. Referring to FIG. 6, a system includes a line creating apparatus 1 and a pin 21. The interplay of the line creating apparatus 1 and pin 21 as well as the tile 16 and sticky notes 23 allows for a more dynamic interaction with a surface 5.

### Example 2

During a product development meeting, new improvements for a product are written on a magnetic dry-erase board. The improvements are listed on various parts of the board. The reel of the apparatus is placed on certain improvements. A first reel is connected with a second reel, and further connected with a third reel to “connect” two or more ideas together.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A line establishing apparatus, comprising:
a first reel, the first reel further comprising:
a first housing, a first spool, a first torsion spring, and a cord; the first spool further comprising an annular opening, the first torsion spring having a first end and a second end, the first torsion spring positioned within the first spool annular opening, the first end of the first torsion spring affixed to the first housing, and the second end of the first torsion spring affixed to the first spool, the first spool rotatable within the first housing, the cord further comprising a first end and a second end, the cord first end attached to the first spool, and partially wound about the first spool, the cord exiting the first housing through a first housing opening; and
a second reel, the second reel further comprising:
a second housing, a second spool, and a second torsion spring; the second spool further comprising an annular opening, the second torsion spring having a first end and a second end, the second torsion spring positioned within the second spool annular opening, the first end of the second torsion spring affixed to the second housing, and the second end of the second torsion spring affixed to the second spool, the second spool rotatable within the second housing, the cord second end attached to the second spool, and partially wound about the second spool, the cord exiting the second housing through a second housing opening.

2. The line establishing apparatus of claim 1, further comprising an identification apparatus held in place on the cord at a point between the first reel and second reel.

3. A line establishing apparatus, comprising:
a first reel, the first reel further comprising:
a first housing, a first spool, a first torsion spring, and a first cord; the first spool further comprising an annular opening, the first torsion spring having a first end and a second end, the first torsion spring positioned within the first spool annular opening, the first end of the first torsion spring affixed to the first housing, and the second end of the first torsion spring affixed to the first spool, the first spool rotatable within the first housing, the first cord further comprising a first end and a second end, the first cord first end attached to the first spool, and partially wound about the first spool, the first cord exiting the first housing through a first housing opening, the first cord second end attached to a first attachment end; and
a second reel, the second reel further comprising:
a second housing, a second spool, a second torsion spring and a second cord; the second spool further comprising an annular opening, the second torsion spring having a first end and a second end, the second torsion spring positioned within the second spool annular opening, the first end of the second torsion spring affixed to the second housing, and the second end of the second torsion spring affixed to the second spool, the second spool rotatable within the second housing, the second cord further comprising a first end and a second end, the second cord first end attached to the second spool, and partially wound about the second spool, the second cord exiting the second housing through a second housing opening, the second cord second end attached to a second attachment end;
wherein the first attachment end attaches to a second attachment through an attachment feature.

4. A system for establishing a line, comprising:
a line establishing apparatus, further comprising:
a first reel, the first reel further comprising:
a first housing, a first spool, a first torsion spring, and a first cord; the first spool further comprising an annular opening, the first torsion spring having a first end and a second end, the first torsion spring positioned within the first spool annular opening, the first end of the first torsion spring affixed to the first housing, and the second end of the first torsion spring affixed to the first spool, the first spool rotatable within the first housing, the first cord further comprising a first end and a second end, the first cord first end attached to the first spool, and partially wound about the first spool, the first cord exiting the first housing through a first housing opening, the first cord second end attached to a first attachment end;
a second reel, the second reel further comprising:
a second housing, a second spool, a second torsion spring and a second cord;
the second spool further comprising an annular opening, the second torsion spring having a first end and a second end, the second torsion spring positioned within the second spool annular opening, the first end of the second torsion spring affixed to the second housing, and the second end of the second torsion spring affixed to the second spool, the second spool rotatable within the second housing, the second cord further comprising a first end and a second end, the second cord first end attached to the second spool, and partially wound about the second spool, the second cord exiting the second housing through a second housing opening, the second cord second end attached to a second attachment end;
wherein the first attachment end attaches to a second attachment through an attachment feature; and
a pin, said pin comprising a first end and a second end;
an indent located between the first end and the second end, said indent configured to receive the cord; and
the second end comprising a magnet.
